(19) United States
(12) Patent Application Publication
(10) Pub. No.: US 2016/0283565 A1
(43) Pub. Date: Sep. 29, 2016

(54) ASSISTANCE PROCESSING APPARATUS, SYSTEMS, AND METHODS

(71) Applicant: NCR Corporation, Duluth, GA (US)

(72) Inventor: Jason Taylor, Suwanee, GA (US)

(21) Appl. No.: 14/670,695

(22) Filed: Mar. 27, 2015

(51) Int. Cl. G06F 17/30; G06Q 20/20

(52) U.S. Cl. CPC G06F 17/30554; G06Q 20/20

(57) ABSTRACT

Various embodiments of apparatus, systems, and methods operate to identify a device and a status using information obtained from the device. Further activity includes determining a course of action based on the status, accessing a database to retrieve action information for the action, and displaying at least some of the action information on a display as part of the course. Additional apparatus, systems, and methods are disclosed.

### BACKGROUND INFORMATION

In today's economic environment, employees often transfer between locations and employers. The tension between the need for training new employees, and its inherent cost, sometimes gives rise to dissatisfaction at retail sales locations. For example, customers of an establishment may be unhappy with the degree of training provided, while the employer struggles to quickly and efficiently train employees. These circumstances can arise in many types of business, including those that use self-checkout systems.

In the self-checkout environment, a notable percentage of service calls per machine per year (SCMY) and early life failure (ELF) calls have been related to the lack of store staff training, and/or the effort needed to resolve operational issues, such as the presentation of error codes by equipment in the lane. A natural corollary is that on-the-job training for self-checkout systems can result in higher than expected lane down time, as well as higher than expected service call rates. Each affects the employer, the employee, and the retail sales customer.

Another complication arises when software updates are not made in a timely fashion. Sometimes these updates involve changes or enhancements to error messaging that provide more detailed and/or simplified troubleshooting. When such updates occur slowly, operational issues often take more time to resolve than might otherwise be expected.

### SUMMARY

Various embodiments herein include at least one of apparatus, systems, and methods that enable more efficient software updates, as well as training. One embodiment, in the form of a method, includes identifying a device and a status using information obtained from the device; determining a course of action based on the status; accessing a database to retrieve action information for the action; and displaying at least some of the action information on a display as part of the course of action.

In another embodiment, an apparatus includes a camera to acquire at least one image; a memory comprising instructions; and a processor to execute the instructions, to identify a device and a training or error status associated with the device using the at least one image, wherein the image comprises an image of the device, a barcode on or near the device, a message displayed on a display communicatively coupled to the device, or a lighted indicator pattern provided by the device, and wherein the processor is to further execute the instructions to determine a course of training or troubleshooting responsive to the status. Additional elements include a bus to receive information associated with the course of action from the memory or from a database, wherein the processor is to execute the instructions to retrieve the information associated with the course using the bus; and a display communicatively coupled to the processor, to display at least some of the information as part of the course of action, including operational training or troubleshooting associated with the device.

A system embodiment includes at least one barcode scanning device; at least one data processing device; and at least one memory device storing a local database of barcode data and instructions executable by the at least one data processing device, the instructions executable by the at least one data processing device to perform data processing activities, the data processing activities comprising: displaying one of a training or error status associated with the system using at least one of a message displayed on a display communicatively coupled to the system, or a lighted indicator pattern, to initiate provision of a course of training or troubleshooting responsive to the status, as determined by a portable apparatus having a camera to acquire an image of the display and/or the lighted indicator pattern. These and other embodiments will now be described in further detail.

### BRIEF DESCRIPTION OF THE DRAWINGS

FIG. 1 is a block diagram of a checkout station that includes a scanner, and portable apparatus, according to an example embodiment.

FIG. 2 is block diagram of networked system components, according an example embodiment.

FIG. 3 is a flow diagram of a method, according to an example embodiment.

### DETAILED DESCRIPTION

To address the challenges noted above, as well as others, some embodiments operate to solve the technical problem of timely software installation, including updates. When software updates can be more easily and quickly put in place, the number of SCMY and ELF calls related to their absence might be reduced. This reduction may in turn reduce lane down time for retailers and customers alike.

In some embodiments, portable apparatus, such as cellular telephones or tablets are used to enable low cost training and troubleshooting for self-checkout systems, as well as other systems. Such embodiments might make use of a single smart phone or tablet that a customer service manager uses when new or updated training is to be implemented. For example, in some cases the portable device could be programmed with an application (e.g., an “app”) to walk through the training while standing in a self-checkout lane. This method of use would permit up-to-date training information and error messages to be presented, even when equipment in the lane was not kept current, perhaps due to delayed retail software test and release cycles.

In some embodiments, the portable apparatus might use several different mechanisms to identify a particular self-checkout system configuration or component. For example, a one- or two-dimensional barcode (e.g., a Quick Response, or QR Code®) located near the serial number of the lane scanned by the portable apparatus might be imaged and used to trigger further activity. Similarly, Bluetooth® communication or other wireless communication might be received by the portable apparatus from one or more system components. In some cases, light-emitting diode (LED) signaling (e.g., flashes, blinking) can be imaged and interpreted by the portable apparatus, perhaps to indicate a particular error associated with a specific piece of equipment in the lane.

In some self-checkout lanes, and other systems, one or more of these mechanisms might form a part of various elements as-manufactured, to indicate an error condition. In others, the capability can be added as an aftermarket feature. For example, in some currency and printer devices, an onboard LED provides a blinking sequence to indicate certain error conditions. Thus, an application can be developed for use in portable devices, to operate according to the methods describes herein, so that a camera attached to the portable apparatus can be used to capture the LED blinking sequence, which is then automatically interpreted to determine which error is indicated, and to initiate further processing.

In some embodiments, once a lane configuration or device that presents an error condition is identified, the portable apparatus, operating according to an application program, presents a menu that permits selection of the type of diagnostic or support information to be shown. This content could be presented in the form of video, PDF, a web site page, or a basic text file, among other options. In this way, employees that have access to the portable apparatus would be able to learn how to rapidly diagnose and troubleshoot errors and other issues, resulting in lower lane down time and lower SCMY/ELF call rates.

In some embodiments, a system that provides optical, wireless, or some other indication of an error during operations comprises a bi-optic scanner, such as NCR RealScan™ 7879 Bi-Optic Imager available from NCR Corporation of Duluth, Ga. (hereinafter the “7879 scanner”). This system can operate as a POS checkout device, with a POS terminal, printer, keyboard, display, magnetic stripe reader (MSR), and POS software. Thus, many embodiments may be realized.

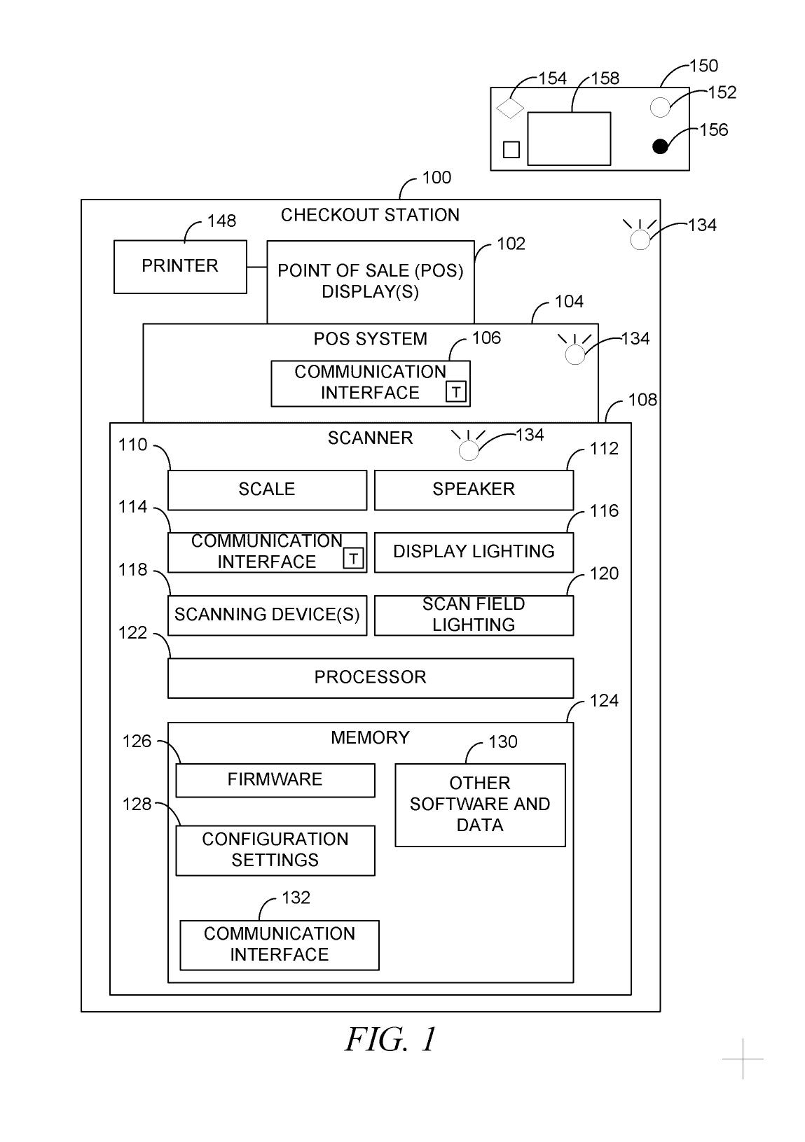

For example, FIG. 1 is a block diagram of a checkout station 100 that includes a scanner 108, and portable apparatus 150, according to an example embodiment. It is noted that the checkout station 100 is shown schematically in greatly simplified form, with example components relevant to understanding the various embodiments described herein. This simplification is also in effect for components of the portable apparatus 150, which may comprises a cellular telephone, a tablet, or some other portable device, such as a Bluetooth® headset. Thus, the checkout station 100 and portable apparatus 150 may include more or less components in some embodiments.

Examples of other terminal types that may include a scanner 108 are self-service terminals (SSTs), clerk operated and self-service library checkout stations, time-keeping terminals, Pay-at-the-Pump terminals attached to a fuel pump at a fueling station, and the like.

The methods of some embodiments are programmed as executable instructions in memory and/or non-transitory computer-readable storage media and executed on one or more processors and other such data processing devices associated with the components and devices herein. Thus, in some embodiments, a non-transitory machine-readable storage device comprises instructions stored thereon, which, when performed by a machine, cause the machine to become a customized, particular machine that performs operations comprising one or more features similar to or identical to those described with respect to the methods and techniques described herein. A machine-readable storage device, herein, is a physical device that stores information (e.g., instructions, data), which when stored, alters the physical structure of the device. Examples of machine-readable storage devices can include, but are not limited to, memory in the form of read only memory (ROM), random access memory (RAM), a magnetic disk storage device, an optical storage device, a flash memory, and other electronic, magnetic, or optical memory devices, including combinations thereof.

The physical structure of stored instructions in the memory 124 may be operated on by one or more processors such as, for example, the processor 122. Operating on these physical structures can cause the machine to become a specialized machine that performs operations according to methods described herein.

The checkout station 100 includes one or more POS displays 102 that present information of a POS system 104 coupled to the one or more POS displays. Information presented by the one or more POS displays includes information relevant in a retail context and with regard to operation of the checkout station. The checkout station 100 also includes one or more scanners 108.

The scanner 108 may be referred to as a barcode scanner as that is the task most commonly associated with such devices. An example of such a barcode scanner is the 7879 scanner. During operation of the checkout station 100, items are placed within a scan field of the scanner 108. One or more scanning devices 118 of the scanner 108, such as one or more of a camera and a laser scanner then scan a barcode and information read therefrom is communicated to the POS system 104. The POS system 104 then uses that data to identify the item placed within the scan field of the scanner 108 and performs an additional function. The additional function may include a price lookup and addition of the item to a list of items to be purchased, which may be presented on the one or more POS displays 102.

The scanner 108 may include one or more scan fields, such as two scan fields of bi-optic scanners that are in use in grocery and discount retail outlets, and well known to those of ordinary skill in the art. In addition to the scanning devices 118, the scanner 108 may include various other components. The various other components may include an integrated scale 110 such as may be used in a grocery outlet to weigh produce and one or both of a speaker 112 and display lighting 116 to output audio and visual signals such as signals indicating successful and/or unsuccessful scans. The scanner 108 may also include scan field lighting 120 that may be turned on and off and adjusted based on a detected presence of an item to be scanned.

During operation, the scanner 108 functions according to instructions executed on a processor 122. The processor 122 may comprise an application integrated circuit (ASIC), a digital signal processor, a microprocessor, or another type of processor. The instructions may comprise firmware 126 or software 130 stored in one or more memories 124. The one or more memories 124 may comprise volatile and/or non-volatile memories, write-protected memories, write-once memories, RAM, ROM, and other memory and data storage types and devices.

The instructions stored in firmware 126 and/or as software 130 in memory 124 are executed according configuration settings stored in the memory 124. The configuration settings 128 configure operation of the scanner 108, and various components, both hardware and software, therein. For example, the configuration settings 108 may operate to configure the volume of the speaker 112, display lighting 116 operation, brightness of the scan field lighting 120, selection of a decoding algorithm for the scanning device(s) 118, and the selection of one or more communication protocols used to communicate data from the scanner 108 to the POS system 104, via a wired or wireless communication interface 106 of the POS system 104 to a physical communication interface device 114 or virtualized communication interface 132 of the scanner 108. For example, in some embodiments, the communication interface 106 of the POS system 104 is accessible from the scanner 108 as a virtualized communication interface 132 maintained in the memory 124 by a process that executes on the processor 122. Each of the communication interfaces 106, 114 may comprise wired or wireless communication interface devices, such as a wired Ethernet device, a wireless Ethernet device (e.g., a device capable of communicating according to one or more of the 802.11 standards), a Bluetooth® communication device, a mesh network device or other peer-to-peer type networking device, a mobile network data communication device, and the like.

In some embodiments, during the operation of the station 100 or the scanner 108, or any of the other elements shown in the figure, an error condition arises. This may be the result of equipment malfunction, failure to scan, a lack of paper in the printer 148, an over- or under-weight condition associated with the scale 110, etc. The individual element involved, such as the scanner 108, the POS system 104, or the station 100 may operate to indicate the existence of the error. Such existence may be indicated by a blinking LED 134. Alternatively, or in addition, the error condition might be indicated by a tone or series of tones, emitted by the speaker 112, by a wireless communication sequence (e.g., provided via the communication interface 114), or perhaps as an error message on a display, such as the display(s) 102. Any such indications may be recognized via a camera 152, wireless interface 154 (which may take the form of a transmitter, receiver, or transceiver, including a Bluetooth® transceiver), and/or microphone 156 attached to the portable apparatus 150. Subsequent activity can be indicated and/or directed by the display 158 of the portable apparatus 150, and/or the display 102 of one or more elements within the station 100.

Various embodiments herein operate to maintain an assistance database, and enable access to it. Access may be accomplished via individual elements of the station 100 or the portable apparatus 150, or both. For example, in some embodiments, the assistance database is stored in the memory 124 of the scanner 108, perhaps as part of the other software and data 130. This local database, in some embodiments, is a self-learned database that is built or augmented over time as error codes are presented and resolved, with the solution sequences being communicated back to the scanner 108 by the POS system 104. In some embodiments, the scanner database may alternatively, or in addition, be obtained or augmented with data from a remote assistance database maintained on a network and accessed by the scanner 108 via a communication interface 114 of the scanner 108. As mentioned elsewhere herein, the communication interface 114 may be a network interface device, such as a wired or wireless Ethernet device. In some embodiments, data from the local database may also be communicated via the communication interface 114 to a network service that synchronizes data in the database maintained on the network.

In some embodiments, the software 130 stored in memory 124 includes instructions executable on the processor 122 to automatically set the configuration settings 128, such as upon scanner 108 installation, completion of scanner 108 maintenance, or other times with regard to the scanner 108. In some embodiments, the software 130 stored in the memory 124 includes instructions executable by the processor 122 to operate the LED 134, speaker 112, communications interface 132 (e.g., to transmit and receive wireless communication), and/or display(s) 102 to indicate an error condition that can be recognized by the portable apparatus 150.

In some embodiments, a group of scanners 108 deployed on a network may share a database accessible via a network by communication interfaces 114 of the respective scanners 108. In other embodiments, the various scanners 108 may synchronize their local databases among each other in a Peer-to-Peer (P2P) manner or via a network service or shared database accessible via the network. Thus, a local database, or another database as described herein, that stores data may be take different forms and store different data (e.g., rules and records of instructions) in various embodiments.

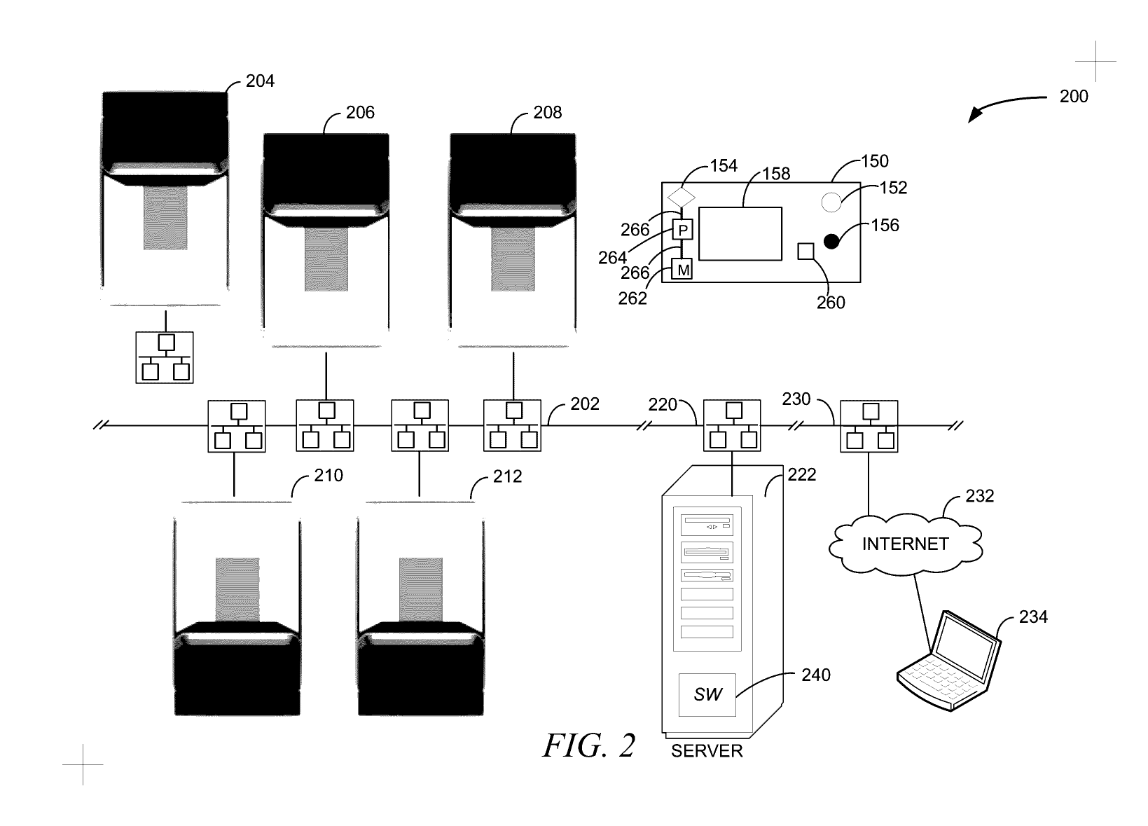

FIG. 2 is block diagram of networked system 200 components, according an example embodiment. The system 200 is a view of a networked system including scanners or Self Service Terminals 206, 208, 210, 212 connected to a network segment 202. The network segment 202 may be a stand-alone network, such as a network within a retail outlet. The network segment 202 may also be part of a larger network that includes additional network segments 220, 230. For example, the network segment 202 may be a store-based network that is also coupled a corporate network segment 220. The corporate network segment 220 may further be coupled to an global network, such as the Internet 232 via network segment 230.

The network segment 202 includes the plurality of scanners or Self Service Terminals (SSTs) 206, 208, 210, 212 connected thereto. The system 200 also includes a scanner/SST 204 that has not yet been connected to the network segment 202. In some embodiments, once the scanner/SST 204 is connected to the network segment 202, a configuration process will execute within the scanner/SST to automatically set its configuration. This may include discovering its configuration through communication with one or more of the other scanners/SSTs 206, 208, 210, 212, requesting configuration setting data from a server 222 that may be accessible via the network segment 202, the corporate segment network 220, the network segment 230, and/or the Internet 232. These configuration settings may include data to be stored on the scanner 204/SST as a local database of data, which may include barcode data, error data, training data, and software update data. Further, the configuration settings may also be pushed to, or otherwise remotely sent to the scanner/SST 204, or to other sca/SSTsnners 206, 208, 210, 212 from the server or from a computing device 234 that may be connected to the Internet 234, the corporate network segment 220, or the network segment 202 via an interface of the scanners/SSTs 204, 206, 208, 210, 212 as discussed above. In some embodiments, local databases of data stored in the memories of the scanners/SSTs 204, 206, 208, 210, 212 maybe synchronized via one or more of the network segments 202, 220, 230 via P2P processes that execute on the scanners/SSTs 204, 206, 208, 210, 212, via a process on the server 222, or otherwise. In some embodiments, a software (SW) update database 240 may be located on a server 222.

The scanners/SSTs 204, 206, 208, 210, 212 may be similar to or identical to the scanner 108 shown in FIG. 1, or parts of, or even the entire station 100 shown in FIG. 1. Thus, although not illustrated, the scanners 206, 208, 210, 212 may be coupled to terminals, such a POS terminals, self-service kiosks and/or terminals, and the other types of terminals discussed elsewhere herein (e.g., POS system 104 and checkout station 100 of FIG. 1). The portable apparatus 150 can thus be used in conjunction with the scanners 204, 206, 208, 210, 212, and/or associated POS terminals or checkout stations to recognize a device (e.g., a scanner, printer, a display terminal, etc.) and status (e.g., an error or training status) using information obtained from the device, and to responsively determine a corresponding course of action.

Therefore, as will become apparent to those of ordinary skill in the art, after reviewing this document and FIG. 2, some embodiments can implement the functions described herein as part of the activity of two or more specific interconnected hardware modules or devices with related control and data signals. These control and data signals may be communicated between and through the modules, or as portions of an application-specific integrated circuit. Thus, the example process flow that follows is applicable to software, firmware, and hardware implementations.

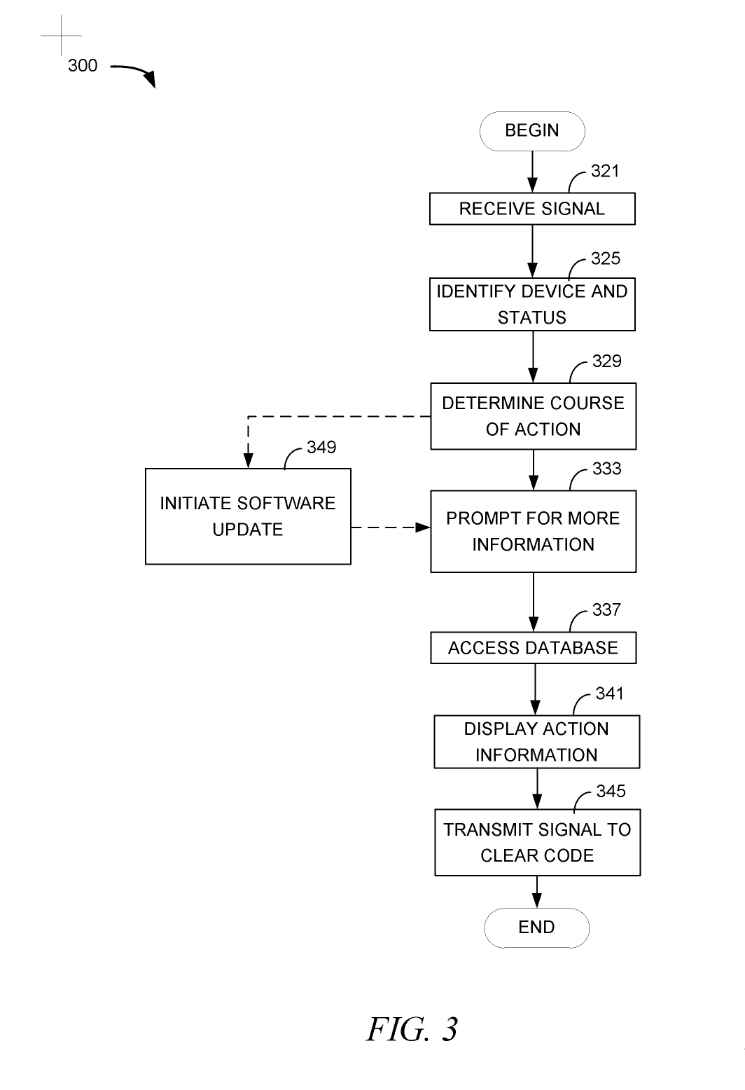

FIG. 3 is a flow diagram of a method 300, according to an example embodiment. The method 300 is an example of a method that may be performed on the portable apparatus 150 of FIG. 1 or 2, such as a cellular telephone, tablet, laptop computer, or some other portable device that includes an imaging device (e.g., camera), processor, and instructions to execute the method.

In some embodiments, the method 300 comprises identifying a device and status (e.g., with respect to whether training or troubleshooting are desired) at block 325, retrieving appropriate information from a database at block 337, and displaying the information at block 341.

In some embodiments, the portable apparatus 150 can initiate identification of the device (e.g., any element of the station 100 or system 200), as well as identification of a status (e.g., error status or training status) associated with the device. For example, a key press, a touch screen activation, a verbal command, or simply the display of an error code (or flashing LED) can be used to start the identification process.

Thus, referring now to FIGS. 1-3, it can be seen that the method 300 may begin at block 317 with receiving an electronic signal to initiate identifying a device, such as a scanner, printer, etc. that presents an error condition, or for which operational training is desired. The electronic signal to initiate identification of the device may be provided by the device to be identified, perhaps in the form of an image, light, sound, or wireless communication. In some embodiments, activating a key 260 or receiving a touch on the screen 158 of the portable apparatus 150 will initiate the identification process. This form of apparatus-initiated activity may be useful in training scenarios, or in cases where identification is based on a barcode that is placed near or on the device to be identified.

In some embodiments, the method 300 continues on from block 321 to block 325 to include identifying a device and a status using information obtained from the device.

Different types of status can be identified, in different ways. For example, and audio file comprising a series of beeps can identify the device and its status, in a manner similar to a series of flashes or blinks from an LED or other visual indicator. Thus, identifying the status at block 325 may comprise identifying the status as one of a training status or an error status using data extracted from an image acquired with a camera 152 or an audio file acquired with a microphone 156.

As noted previously, a blinking LED on the device to be identified can be used to both identify the device, and the status. Thus, in some embodiments, the device is identified using a first portion of a lighted indicator pattern comprising a blinking light emitting diode attached to the device, and the status is identified as an error code indicated by a second portion of the lighted indicator pattern.

In some embodiments, the device and status can be identified in a number of other ways. Thus, the activity at block 325 may comprise identifying the device and the status using information comprising at least one of an image of the device, a barcode on or near the device, a message displayed on a screen communicatively coupled to the device, a wireless signal emitted by the device, a sound pattern emitted by the device, or a lighted indicator pattern provided by the device.

For example, a few possible identification scenarios include: (1) receiving multiple images over time, of a blinking LED, and using the images and timing to identify the device, and its status; (2) receiving a sequence of sonic indications, and decoding a recorded sound file (or real-time digitization) of the indications to identify the device, and its status; (3) receiving a wireless transmission, and decoding some portion of the transmission to identify the device, and its status; (4) receiving an image of a screen included in the device, and using optical character recognition of a message displayed on the screen to identify the device, and its status. Many others are possible, but not listed here in the interest of brevity.

In some embodiments, the method 300 continues on from block 325 to block 329, to include determining a course of action based on the status.

For example, an update of outdated software, which may be the source of an error display, can be initiated by the portable apparatus. Thus, activity at block 329 may comprise determining, based on the status, that software installed on the device, or running on a processor communicating with the device, is outdated. When this occurs, the method 300 may continue on to block 349, to include initiating an update sequence of the software.

Erroneous, outdated, or brief error displays may be corrected and/or enhanced to assist a user (e.g., store employee) in correcting an error condition. Thus, as part of this activity at block 329, the method 300 may include determining that information displayed on a display communicatively coupled to the identified device corresponds to an erroneous, outdated, or abbreviated error code.

Depending on the identified status, the appropriate course of action may be training, or troubleshooting, among others. Thus, in some embodiments, the course of action comprises one of a course of training or a course of troubleshooting.

When it is useful, such as when a particular element of the device should be replaced (e.g., a printer, or paper for the printer), an audible, visible, or tactile prompt can be given to gather additional information to refine instructions to the user. Thus, in some embodiments, the method 300 may include, at block 333, prompting for acquisition of additional identification information associated with the device, to include prompting acquisition of an image of one or more components associated with the device.

In some embodiments, the method 300 continues from block 333 to block 337, to include accessing a database to retrieve action information for the course of action determined at block 329. In this way, assistance may be rendered with respect to operational training on the device, or troubleshooting operation of the device. Thus, the action information may comprise one of operational training or troubleshooting associated with the device.

In some embodiments, the method 300 continues from block 337 to block 341 to include displaying at least some of the action information on a display as part of the course of action. The display that is used may be a display that is communicatively coupled to the portable apparatus 150, such as a local display 158, or perhaps a remote display, to include display(s) 102 on a device that has been identified. Other displays, such as a display on another computing device 234, may be used. Thus, in some embodiments, the activity at block 341 may comprise displaying some of the action information on a display coupled to a portable apparatus as a corrected, current, or enhanced error code reporting message.

The updated/enhanced error message may be accompanied by instructions for clearing the error code/message. Thus, in some embodiments, the corrected, current, or enhanced error code reporting message includes or is augmented by displaying instructions to clear the erroneous, outdated, or abbreviated error code.

The portable apparatus, in some embodiments, may operate to clear the error code by transmitting a command. Thus, in some embodiments, the method 300 includes, at block 345, transmitting an electronic signal to the device to clear an error code associated with the status. Many other embodiments may be realized.

For example, another embodiment takes the form of a portable apparatus 150, such as the portable apparatus 150 shown in FIGS. 1 and 2. The apparatus (e.g., phone, tablet) may operate to run a software application stored in a memory 262, that activates a camera 152 to acquire image(s), and a processor 264 to decode the image(s) to identify the device in question, and the circumstances surrounding identification, as well as to retrieve and display appropriate information on a display 158.

Thus, in some embodiments, a portable apparatus 150 comprises a camera 152 to acquire at least one image, as well as a memory 262 and a processor 264. The memory 262 that can be used to store the image, as well as instructions. The processor 264 can operate to execute the instructions stored in the memory 262, to identify a device and a training or error status associated with the device using the at least one image. For example, the image may comprise an image of the device, a barcode on or near the device, a message displayed on a display communicatively coupled to the device, or a lighted indicator pattern provided by the device. The processor 262 can further operate to execute the instructions in the memory 262 to determine a course of training or troubleshooting responsive to the status.

Some embodiments of the apparatus 150 comprise a bus 266 to receive information associated with the course of action from the memory 262 or from a database (e.g., via the wireless interface 154), wherein the processor 264 is to execute the instructions in the memory 262 to retrieve the information associated with the course of action using the bus 266.

The apparatus 150 may further include a display 158 communicatively coupled to the processor 264, to display at least some of the information as part of the course of action, including operational training or troubleshooting associated with the identified device.

Thus, in some embodiments, a wireless receiver (e.g., Bluetooth® receiver) can be included to identify the device and status. That is, the apparatus 150 may comprise a wireless receiver (in the form of a wireless interface 154) to acquire a signal transmitted by the device, wherein the processor 264 is to execute the instructions in the memory 262 to identify the device and/or the training or error status associated with the device using information carried by the signal.

Similarly, a wireless transmitter (e.g., Bluetooth® transmitter) can be used to initiate, and even conduct, software updates associated with the device. Thus, in some embodiments, the apparatus 150 may comprise a wireless transmitter (in the form of a wireless interface 154) to transmit an update signal to initiate a software update for software installed on the device (e.g., processor 122 in the scanner 108), or a processor communicating with the device, responsive to a determination that the software is outdated.

A variety of user interface devices can be activated to begin the identification process. Thus, in some embodiments, the apparatus 150 comprises a microphone 156, a switch 260, or a touch screen sensor (as part of the display 158) to provide a signal initiating acquisition of one or more images by the camera 152.

The wireless interface 154 may serve as a network interface that can be used to facilitate access to a database containing training/troubleshooting instructions. Thus, in some embodiments, the apparatus 150 comprises a network interface to couple the processor 264 to the database, via the bus 266.

Some embodiments comprise parts of a system. For example, a system 200 may comprise one or more scanners 204, 206, 208, 210, 212 and other elements (e.g., printers, terminals, etc.) that can interact with a portable apparatus 150 to initiate a course of action that includes assistance with training or troubleshooting.

Thus, in some embodiments, a system such as the station 100 comprises at least one barcode scanning device 108, with at least one data processing device 122 and at least one memory device 124 storing a local database (e.g., as part of the other software and data 130) of barcode data and instructions executable by the at least one data processing device 122. The instructions are executable by the at least one data processing device 122 to perform data processing activities comprising displaying one of a training or error status associated with the system using at least one of a message displayed on a display 102 communicatively coupled to the system, or a lighted indicator pattern (e.g., produced by an indicator, such as one of the LEDs 134, or perhaps a dedicated area of the display 102), to initiate provision of a course of training or troubleshooting responsive to the status, as determined by a portable apparatus 150 having a camera 152 to acquire an image of the display 102 and/or the lighted indicator pattern produced by the indicator.

The scanner may be part of a Self-Service Terminal. Thus, in some embodiments, the scanning device 108 forms a part of a transaction processing system that comprises a Self-Service Terminal (SST).

The system, which may there include a Self-Service Terminal, may comprise a Point-Of-Sale system. Thus, the SST may comprise a self-checkout Point-Of-Sale (POS) system.

The system may include a wireless transmitter to transmit the status to the portable apparatus. Thus, the system may comprise a wireless transmitter to transmit the training or error status to the portable apparatus. This transmitter (and companion wireless receiver, perhaps forming part of a wireless transceiver T) may form part of the communication interfaces 114 or 106.

The system may include a wireless transceiver to communicate with the portable apparatus, and to receive commands from the portable apparatus to update outdated software. Thus, in some embodiments, the system comprises a wireless transceiver T to communicate with a portable apparatus 150 that is programmed to determine the status, and to initiate an update sequence for software installed on the system when the portable apparatus determines the software is outdated. Many other embodiments may be realized, but are not explicitly described here in the interest of simplicity and brevity.

In summary, various embodiments provide value to retailers and consumers alike in providing an opportunity to reduce lane down time, by introducing training for any number of system elements when desired, and troubleshooting when indicated.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, comprising:
identifying a device and a status using information obtained from the device;
determining a course of action based on the status;
accessing a database to retrieve action information for the course of action; and
displaying at least some of the action information on a display as part of the course of action.

2. The method of claim 1, wherein identifying the status comprises:
identifying the status as one of a training status or an error status using data extracted from an image acquired with a camera or an audio file acquired with a microphone.

3. The method of claim 1, further comprising:
receiving an electronic signal to initiate the identifying.

4. The method of claim 3, wherein the electronic signal is provided by the device.

5. The method of claim 1, further comprising:
determining, based on the status, that software installed on the device, or running on a processor communicating with the device, is outdated; and
initiating an update sequence of the software.

6. The method of claim 1, further comprising:
determining that information displayed on a display communicatively coupled to the device corresponds to an erroneous, outdated, or abbreviated error code; and
displaying the at least some of the action information on the display coupled to a portable apparatus as a corrected, current, or enhanced error code reporting message.

7. The method of claim 6, wherein the corrected, current, or enhanced error code reporting message includes or is augmented by displaying instructions to clear the erroneous, outdated, or abbreviated error code.

8. The method of claim 1, further comprising:
prompting for acquisition of additional identification information associated with the device, to include prompting acquisition of an image of one or more components associated with the device.

9. The method of claim 1, further comprising:
transmitting an electronic signal to the device to clear an error code associated with the status.

10. The method of claim 1, wherein the device is identified using a first portion of a lighted indicator pattern comprising a blinking light emitting diode attached to the device, and the status is identified as an error code indicated by a second portion of the lighted indicator pattern.

11. The method of claim 1, wherein the identifying comprises:
identifying the device and the status using the information comprising at least one of an image of the device, a barcode on or near the device, a message displayed on a screen communicatively coupled to the device, a wireless signal emitted by the device, a sound pattern emitted by the device, or a lighted indicator pattern provided by the device.

12. The method of claim 1, wherein the course of action comprises one of a course of training or troubleshooting.

13. The method of claim 1, wherein the action information comprises one of operational training or troubleshooting associated with the device.

14. An apparatus, comprising:
a camera to acquire at least one image;
a memory comprising instructions;
a processor to execute the instructions to identify a device and a training or error status associated with the device using the at least one image, wherein the image comprises an image of the device, a barcode on or near the device, a message displayed on a display communicatively coupled to the device, or a lighted indicator pattern provided by the device, and wherein the processor is to further execute the instructions to determine a course of training or troubleshooting responsive to the status;
a bus to receive information associated with the course from the memory or from a database, wherein the processor is to execute the instructions to retrieve the information associated with the course using the bus; and
a display communicatively coupled to the processor, to display at least some of the information as part of the course including operational training or troubleshooting associated with the device.

15. The apparatus of claim 14, further comprising:
a wireless receiver to acquire a signal transmitted by the device, wherein the processor is to execute the instructions to identify the device and/or the training or error status associated with the device using information carried by the signal.

16. The apparatus of claim 14, further comprising:
a wireless transmitter to transmit an update signal to initiate a software update for software installed on the device, or a processor communicating with the device, responsive to a determination that the software is outdated.

17. The apparatus of claim 14, further comprising:
a microphone, a switch, or a touch screen sensor to provide a signal initiating acquisition of the at least one image by the camera.

18. The apparatus of claim 14, further comprising:
a network interface to couple the processor to the database, via the bus.

19. A system, comprising:
at least one barcode scanning device;
at least one data processing device; and
at least one memory device storing a local database of barcode data and instructions executable by the at least one data processing device, the instructions executable by the at least one data processing device to perform data processing activities, the data processing activities comprising:
displaying one of a training or error status associated with the system using at least one of a message displayed on a display communicatively coupled to the system, or a lighted indicator pattern, to initiate provision of a course of training or troubleshooting responsive to the status, as determined by a portable apparatus having a camera to acquire an image of the display and/or the lighted indicator pattern.

20. The system of claim 19, wherein the scanning device forms a part of the system that comprises a Self-Service Terminal (SST).

21. The system of claim 20, wherein the SST comprises a self-checkout Point-Of-Sale (POS) system.

22. The system of claim 19, wherein the system further comprises:
a wireless transmitter to transmit the training or error status to the portable apparatus.

23. The system of claim 19, further comprising:
a wireless transceiver to communicate with the portable apparatus that is programmed to determine the status, and to initiate an update sequence for software installed on the system when the portable apparatus determines the software is outdated.
